(19) United States
(12) Patent Application Publication
(10) Pub. No.: US 2017/0046653 A1
(43) Pub. Date: Feb. 16, 2017

(54) PLANNING OF TRANSPORTATION REQUESTS

(71) Applicant: Amazon Technologies, Inc., Seattle, WA (US)

(72) Inventors: Darren Edward Wilson, Lynnwood, WA (US); Russell John Allgor, Seattle, WA (US); Patrick Jeffrey Dion, Seattle, WA (US); William Matthew Driegert, Mercer Island, WA (US); William Theodore Gordon, Seattle, WA (US); Gautam Gupta, Mountain View, CA (US); Anicham Ponn Kumarasamy, San Jose, CA (US); Edward McGavin, Indianola, WA (US); Pragyana K. Mishra, Seattle, WA (US); Jonathan Blair Norwood, Seattle, WA (US); Manish Parson, Bothell, WA (US); Sekhar Putcha, Seattle, WA (US); Murali Rajaa Rajamani, Seattle, WA (US); Matthew Robert Sowders, Kirkland, WA (US); Renato Fonseca Furquim Werneck, San Francisco, CA (US); Ronald Mark Whitman, Seattle, WA (US)

(21) Appl. No.: 14/868,682

(22) Filed: Sep. 29, 2015

Related U.S. Application Data
(60) Provisional application No. 62/205,426, filed on Aug. 14, 2015.

(51) Int. Cl. G06Q 10/08

(52) U.S. Cl. CPC G06Q 10/083

(57) ABSTRACT

Techniques for planning of transportation requests may be described. In particular, zones may be generated based on historical information associated with transportation requests, where each zone may be configured to manage a number of the transportation requests. An inter-zone sequence may also be generated relatively statically to indicate an order of progressing between the zones in response to the transportation requests. In addition, an intra-zone sequence for each zone may also be generated relatively dynamically. The intra-zone sequence may indicate an order of progression within the corresponding zone in response to current transportation requests of that zone.

### CROSS-REFERENCE TO RELATED APPLICATIONS

This application claims the benefit of and priority to U.S. Provisional Patent Application No. 62/205,426, filed Aug. 14, 2015, entitled “PLANNING OF TRANSPORTATION REQUESTS,” the content of which is hereby incorporated by reference in its entirety.

### BACKGROUND

An entity may experience a large number and diverse type of transportation requests associated with providing a service. For example, an electronic marketplace may offer items with various delivery and return methods. Users may remotely purchase and/or return some of the items using such methods.

The entity may implement a route planner to manage the demand for the transportation requests. For example, the route planner may generate plans to deliver, pick-up, and/or return items. However, the larger and/or more diverse the demand becomes, the less optimal the plan may become. In certain situations, generating an optimal plan may become computationally infeasible or even impossible.

### BRIEF DESCRIPTION OF THE DRAWINGS

Various embodiments in accordance with the present disclosure will be described with reference to the drawings, in which:

FIG. 1 illustrates an example environment for implementing a transportation planner, according to embodiments;

FIG. 2 illustrates an example delivery area divided into a set of zones, according to embodiments;

FIG. 3 illustrates another example delivery area divided into a set of zones, according to embodiments;

FIG. 4 illustrates an example zone with potential intra-zone sequences, according to embodiments;

FIG. 5 illustrates an example optimization of intra-zone sequences, according to embodiments;

FIG. 6 illustrates an example flow for planning transportation requests, according to embodiments;

FIG. 7 illustrates an example flow for dividing a delivery area into a set of zones, according to embodiments;

FIG. 8 illustrates an example flow for generating an inter-zone sequence, according to embodiments;

FIG. 9 illustrates an example flow for generating an intra-zone sequence, according to embodiments;

FIG. 10 illustrates an example flow for generating routes including multiple zones, according to embodiments; and

FIG. 11 illustrates an example architecture for providing a route planner within a context of an electronic marketplace, including at least one user device and/or one or more service provider devices connected via one or more networks, according to embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to, among other things, planning for transportation requests. A transportation request may represent a request associated with a location and may necessitate transportation to the location to satisfy the request. For example, the transportation request may include a delivery of an item to the location, a pick-up or a return of the item from the location, and/or providing a service at the location (e.g., collecting street images of the location, assisting a client with an operation at the location, etc.). Planning for the transportation requests may include organizing how to respond to the requests. Different implementations may exist to generate a transportation plan. One implementation may utilize a static approach. For example, items to be delivered within an area may be delivered according to the same static sequence of addresses. In this example, if an address is to receive an item, the item may be delivered to the address during a delivery trip along the static sequence; otherwise, the address may be skipped during the delivery trip. The static approach may result in many inefficiencies. Some of the inefficiencies may be caused by the overhead associated with differentiating between the receiving and non-receiving addresses. Other inefficiencies may be caused by travelling the static sequence regardless of the transportation variables (e.g., delivery destinations, customer availability, current conditions of traffic and/or weather, etc.). Another implementation may use a dynamic approach. Under this approach, a transportation route is generated based on actual transportation requests. The transportation route may include only locations of the actual requests and, thus, may change over time (e.g., from one day to the next). Although more efficient than the static approach, the dynamic approach may nonetheless remain sub-optimal and result in many inefficiencies. For example, given a set of delivery locations, the dynamic approach may search for the shortest possible route to deliver the items to the locations. This search may be referred to as finding a solution to the travelling salesman problem. However, if the number of locations exceeds is large (e.g., twenty or greater), finding an optimal solution may become computationally infeasible, impractical, or even impossible. For instance, finding the solution in this scenario may utilize a large number of computational cycles of a processing device such that, by the time the solution is found, the solution may have become meaningless or such that the solution may not be found in a timely manner. To get around this computational challenge, various assumptions and constraints may be imposed which, in turn, may result in a sub-optimal solution. Further, even when a solution is found, the overhead associated with sequencing the deliveries of the items and/or inconsistencies in delivery performances may also contribute to the inefficiencies of the dynamic approach.

Embodiments of the present disclosure provide a hybrid approach. The hybrid approach may segment transportation requests into a plurality of zones, generate a static sequence of the zones, and generate a dynamic sequence within each zone. The segmentation may be based on the historical information about transportation requests and/or based on a desired capacity or throughput per zone. The zones may be sequenced such that transportation requests of one zone may be processed prior to transportation requests of a following zone. This sequence may represent a static sequence or order to progress across the zones (e.g., to travel between the zones). Instead of analyzing all of the transportation requests collectively when searching for an optimal solution, the segmentation may reduce the number of transportation requests to analyze for each zone. In an example, the number of transportation requests to be processed within a zone may be selected to be small enough such that finding the optimal solution for the zone may be computationally possible and meaningful. As such, for each zone, a dynamic sequence may be generated based on current or actual transportation requests. To optimize the dynamic sequences for multiple zones, the dynamic sequence of one zone may account for information about transportation requests of another zone, e.g., an adjoining zone in physical space and/or in the static sequence of the zones. Further, the hybrid approach may simplify or reduce the overhead associated with sequencing the transportation requests across the zones and within each zone as further described herein below.

To illustrate, consider an example of an electronic marketplace and an area of a city. On a daily basis, one thousand items (or some other large number of items) may be purchased from the electronic marketplace and destined to deliveries within the area of the city. Under the hybrid approach, the area may be divided into one hundred geographic zones, each zone planned to handle an average of ten deliveries a day. As such, it may be computationally possible to find the shortest possible route within each zone. While the zones may be defined relatively statically (e.g., once per season, week, month, etc.) based on historical information and updated as needed, an optimal sequence within each zone may be determined dynamically (e.g., on a daily basis, on a shift basis, etc.) given the actual demand. By implementing the hybrid approach, the processing of items may be simplified for a delivery station and for delivery personnel. For example, each zone may be associated with a specific delivery container. At the delivery station, items may be packaged and added to the delivery containers corresponding to the zones. An average of ten packages may be found in a container. User-friendly and distinctive labels may also be added to the packages. At a delivery location within a particular zone, a delivery personnel may determine the container specific to that zone. Afterwards, out of the possible packages (up to ten on average), the proper package may be identified based on the user-friendly and distinctive labels associated with the delivery location.

In the interest of clarity of explanation, embodiments herein may be described within a context of delivering items to delivery locations. Nonetheless, the embodiments are not limited as such. Instead, the embodiments may similarly apply to any type of a transportation request and to any type of a tangible (e.g., physical product, digital media, etc.) or intangible (e.g., service) item.

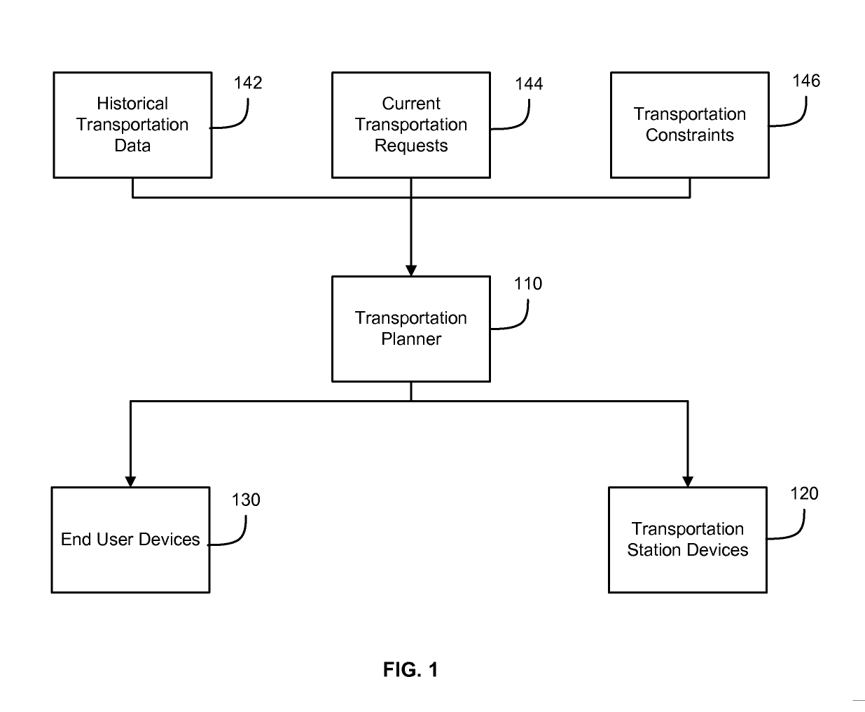

Turning to FIG. 1, the figure illustrates an example computing environment for implementing a transportation planner 110. The transportation planner 110 may be configured to implement the above described hybrid approach. For example, the transportation planner 110 may generate a transportation plan by segmenting transportation requests into a predefined set of zones, generating a static sequence of the zones, and generating dynamic sequences within the zones. The transportation plan may be provided to different subscriber devices, such as transportation station devices 120 and end user devices 130. Each of these devices may utilize the transportation plan to facilitate functionalities and operations to respond to the transportation requests. To generate the transportation plan, the transportation planner 110 may access historical transportation data 142, current transportation requests 144, and/or transportation constraints 146. Each of these components is further described herein next.

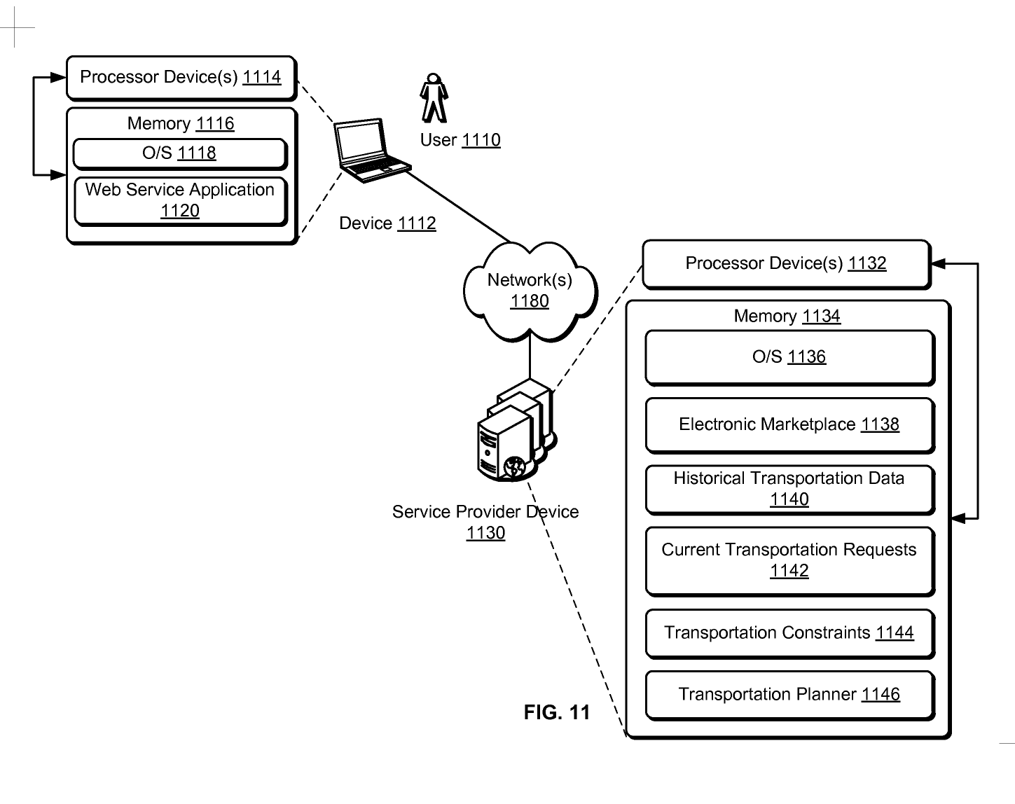

In an example, the transportation planner 110 may be a computing service implemented on specialized hardware or hosted on a platform, such as on a server or on a cloud-based platform. An example implementation is further illustrated in FIG. 11. A service provider may implement the transportation planner 110 to handle, manage, process, and plan for transportation requests. For instance, the transportation planner 110 may be used to generate delivery routes for delivering items to different delivery locations. In one example, the items may be available from an electronic marketplace. In this example, the service provider of the transportation planner 110 may be the service provider of the electronic marketplace or may be a different carrier or entity.

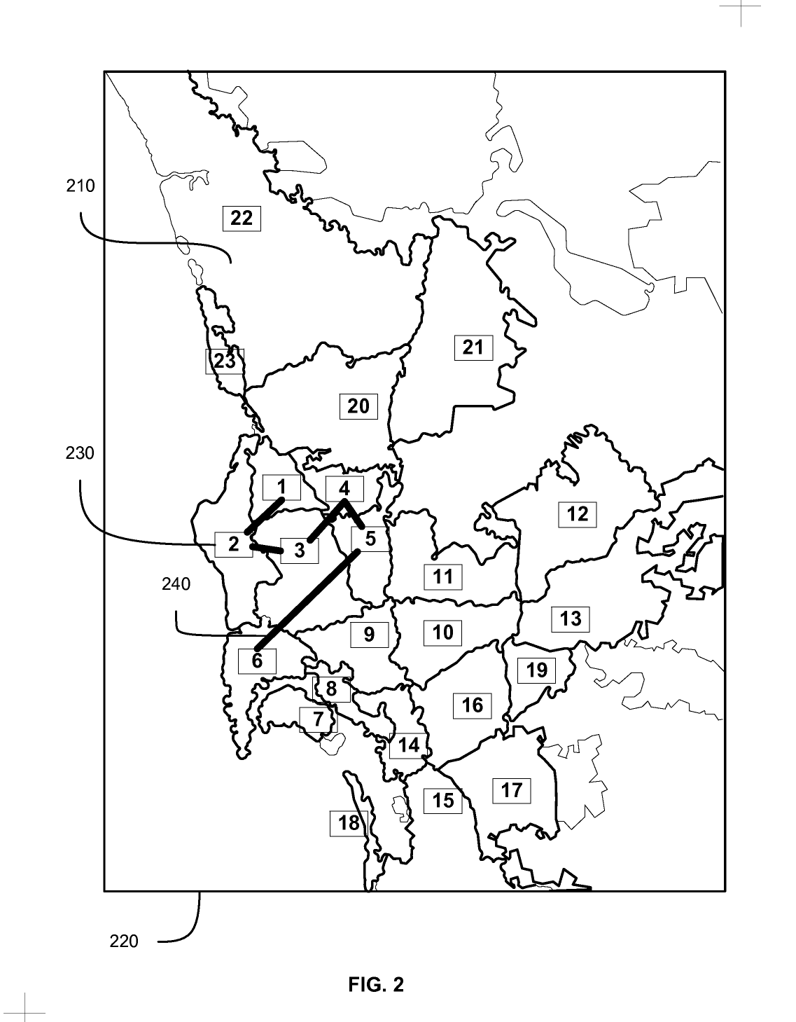

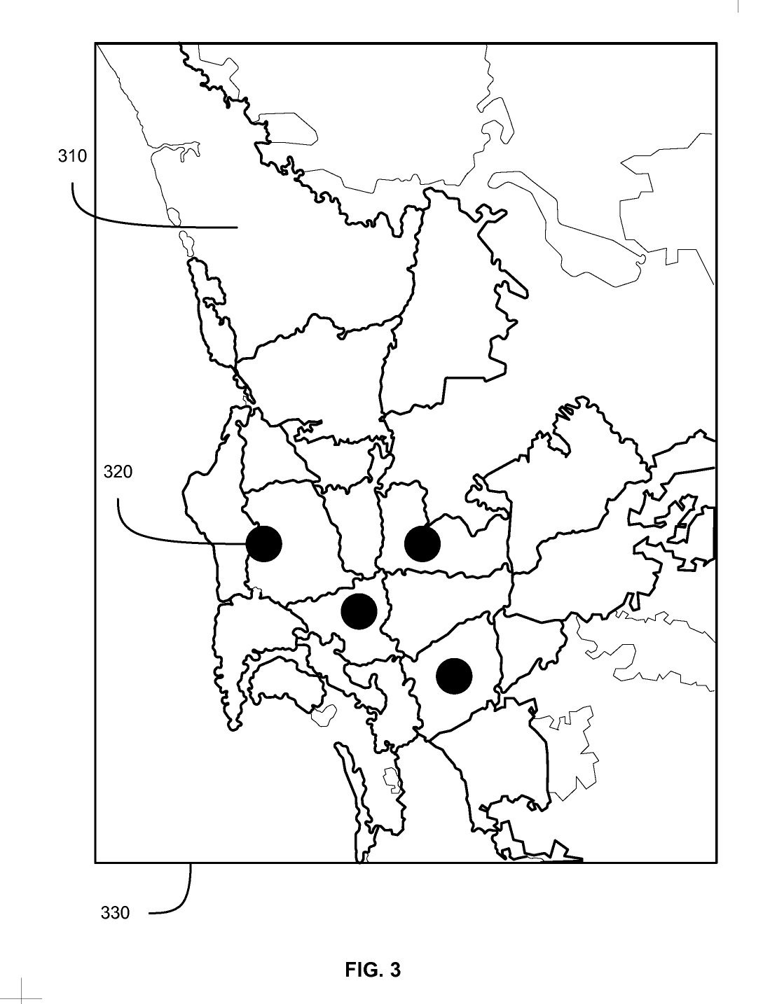

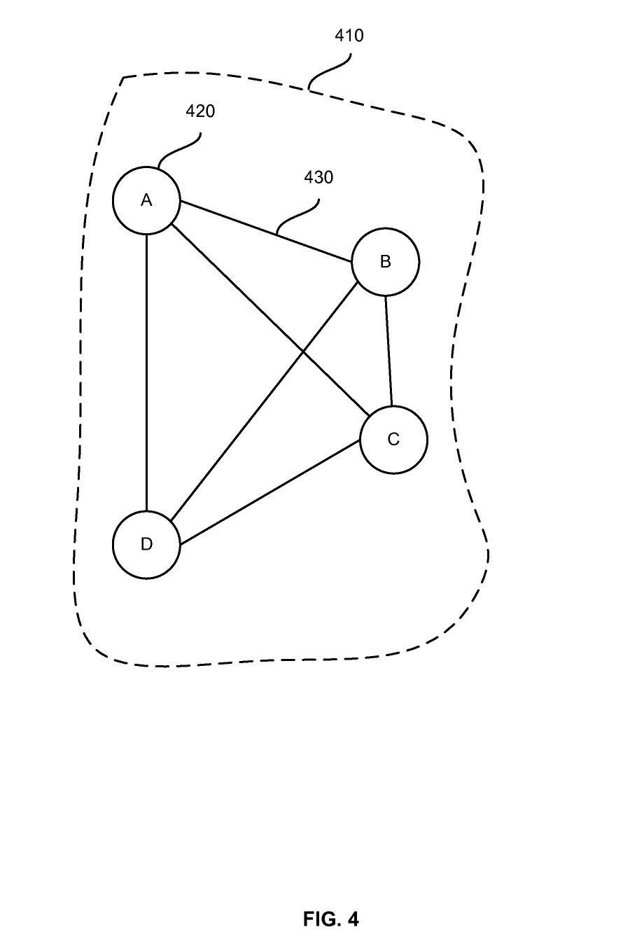

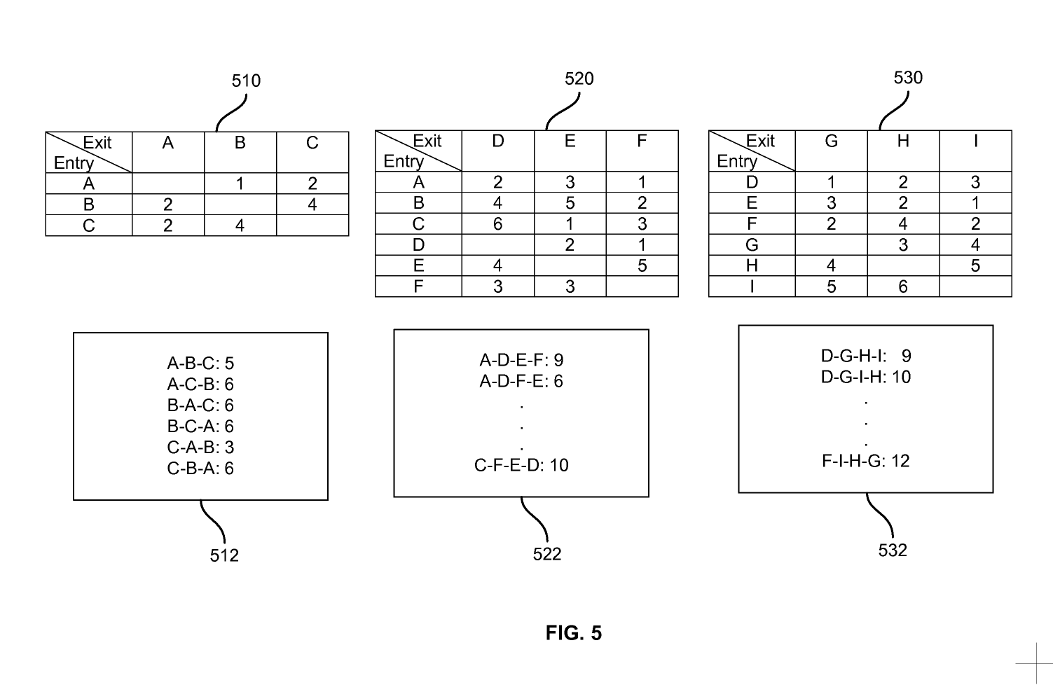

The transportation planner 110 may be configured to output a transportation plan. The transportation plan may include a set of zones, sequenced in a particular order. Examples of such zones and inter-zone sequence are illustrated in FIGS. 2 and 3. The set of zones and the associated inter-zone sequence may be generated based on the historical transportation data 142, based on a desired capacity or throughput per zone, and/or optionally the transportation constraints 146. The transportation plan may also include an intra-zone sequence within each zone. Such an intra-zone sequence may represent an optimal solution to progress through the associated zone and manage the transportation requests specific to that zone. Examples of intra-zone sequences are illustrated in FIGS. 4 and 5. Each intra-zone sequence may be generated based on the current transportation requests 144 and, optionally, the transportation constraints 146. In addition, the transportation planner 110 may group multiple intra-zone sequences into a route by estimating the resulting workload, e.g., number of deliveries, number of delivery locations, travel distance, travel time, number of packages, etc. The transportation plan may identify the routes and the workloads to subscriber devices, thereby allowing subscribers (e.g., transportation stations and transportation personnel) to follow the plan.

To illustrate, the transportation planner 110 may divide a delivery area (e.g., a certain area of a city) into a number (e.g., one hundred) of geographic zones and define a relatively static inter-zone sequence. Each zone may be assigned a different identifier (e.g., a number), where each assigned identifier may identify the sequence or order of the respective zone relative to the other zones. Each zone may also be expected to contain a mean number of item deliveries (e.g., ten deliveries per zone). Accordingly, the transportation planner 110 may output instructions (e.g., a route, a map, an ordered list, etc.) about an order to progress across the geographic zones for delivering items throughout the delivery area. In addition, the transportation planner 110 may output a route for a number of grouped geographic zones (e.g., ten zones). The route may represent, for example, a day's worth of deliveries for a delivery worker (e.g., an eight hour work day or a total of eighty expected deliveries a day). In addition, and within each geographic zone, the transportation planner 110 may output an intra-zone sequence (e.g., a route, a map, a list, etc.) showing how to progress between the delivery locations of the geographic zone (e.g., an expected ten deliveries per zone).

In an example, the transportation station devices 120 may represent, individually or collectively, a computing system associated with a transportation station. A transportation station may include a delivery, sorting, handling, shipment, return or other transportation-related stations. For example, the transportation station may be configured to receive, sort, package, and label items for deliveries or for returns. The transportation station may also be configured to facilitate loading the prepared items into delivery containers and loading the delivery containers onto delivery vehicles or, conversely, unloading delivery containers and items. In an example, these functionalities may be fully or partially automated. The transportation station may utilize one or more of the transportation station devices 120 to provide such functionalities and operations. For example, the transportation station devices 120 may receive a transportation plan from the transportation planner 110. Based on the received plan, the transportation station devices 120 may further instruct users (whether automated or not) about the inter-zone sequence, the intra-zone sequences, and the routes. Accordingly, items to be delivered may be properly prepared and/or scheduled for deliveries. Similarly, items to be returned may be properly prepared and/or scheduled for pickup/return.

The end user devices 130 may represent another example of subscriber devices. In particular, each of the end user devices 130 may include a computing device configured to receive a transportation plan from the transportation planner 110 and to, accordingly, provide a transportation-related operation or functionality to an end user. The end user may but need not be an automated user. The provided operations or functionalities may include providing instructions for handling transportation requests within a zone and across a route based on the intra-zone sequences, the routes, and the inter-zone sequence. In an example, one or more of the end user devices 130 may be attached (integrated, connected to, or interfacing with) delivery and/or return vehicles and may, accordingly, direct certain operations and functionalities of such vehicles. In another example, one or more end user devices 130 may be devices carried by delivery personnel to manage deliveries, pick-ups, and returns of items. In yet another example, the one or more end user devices 130 may be utilized by other subscribers, such as by operations personnel to monitor efficiencies of deliveries and such as by contractors and/or third parties to bid on and accept routes.

The subscriber devices, including the transportation station devices 120 and the end user devices 130, may interface with the transportation planner 110 in different ways. For example, the interface may take the form of a remote interface over a network using an application programming interface (API). In another example, an interface to the transportation planner 110 may be installed at the subscriber devices, such as a standalone application or a browser plugin. Transportation plans generated by the transportation planner 110 may be sent and/or customized to each of the subscriber devices based on a subscription or a subscriber account and may use a push or a pull mechanism.

In an example, the historical transportation data 142, the current transportation requests 144, and/or the transportation constraints 146 may collectively represent data available to the transportation planner 110 to generate the transportation plan. Such data may be stored in one or more data stores accessible to the transportation planner 110 over, for instance, a network. A data store may utilize a database, or some other data storage type, and may be managed by a same or a different service provider as the provider of the transportation planner 110.

The historical transportation data 142 may represent a collection of data about past transportation requests. For example, a service provider may track all of the received and handled transportation requests, thereby forming the historical transportation data 142. The tracked data may include past delivery requests, return requests, delivery locations, return locations, volume or amount of such requests, and/or other past transportation-related data. On the other hand, the current transportation requests 144 may represent data about requests that may have not been handled to completion yet. For example, a service provider may receive a number of transportation requests for items to be delivered and/or returned. Prior to delivering and/or returning these items, these requests may form the current transportation requests 144. In other words, the current transportation requests 144 may include current delivery requests and/or return requests, in addition to transportation-related data such as delivery locations, return locations, and/or volume or amount of such requests. The transportation constraints 146 may represent data that may impact how a transportation request may be handled or managed. This data may be available from a source managed by a service provider of the transportation planner 110 or from a third party. For example, this data may include traffic, weather, ongoing events, user preferences, geographical constraints, and/or other data potentially impacting a transportation request. The transportation planner 110 may use the transportation constraints 146 to optimize one or more elements of a transportation plan given current conditions (environmental and otherwise) that may impact the plan.

Hence, the transportation planner 110 may access different types of data to generate a transportation plan. For example, the transportation planner 110 may access the historical transportation data 142 and, optionally, the transportation constraints 146 to generate zones and inter-zone sequences. Similarly, the transportation planner 110 may access the current transportation requests 144 and, optionally, the transportation constraints 146 to generate routes and intra-zone sequences. By providing an interface to subscriber devices, including the transportation station devices 120 and the end user devices 130, the transportation planner 110 may provide the transportation plan, or at least relevant portions thereof, to such devices, thereby facilitating various transportation-related operations and functionalities.

Turning to FIG. 2, the figure illustrates a plurality of zones 210 that may be generated by, for example, the transportation planner 110. As illustrated, each of the zones may represent a geographic area defined with a set of boundaries. Collectively, the zones 210 may represent a transportation area 220, such as one used for deliveries, returns, or other geographic area used for other types of transportation requests. For example, the transportation area 220 may represent an area of a city where deliveries of items may occur. In comparison, each of the zones 210 may represent a sub-area.

In addition, each of the zones 210 may be associated with an identifier 230, such as a marker or a number, to sequence the zones 210. An identifier 230 may represent a sequence or order of the respective zone relative to the other zones. The collection of identifiers may form an inter-zone sequence 240. The inter-zone sequence 240 may allow a user to progress across the zones 210 in a predefined order between zones. For example, the zones 210 may be numbered “one” through “twenty three” in an ascending fashion (or some other numbering scheme). In this example, “one” may indicate that the corresponding zone is the first zone, “two” may indicate that the corresponding zone is next, and so on until “twenty three” indicating that the corresponding zone is the last one of the zones 210. Thus, a user travelling through the zones may first enter zone “one,” then move to zone “two,” and so on until arriving to zone “twenty three.”

In an example, the transportation planner 110 may generate the zones 210 and the inter-zone sequence 240. For example, the transportation planner 110 may determine a desired capacity (e.g., a throughput of transportation requests to be processed) per zone. Based on historical data of the transportation area 220, the transportation planner 110 may segment the transportation area 220 such that each zone may approximately correspond to a desired capacity. For instance, if the data indicates that the transportation area 220 experiences a daily average of one thousand deliveries and if a desired capacity per zone is ten deliveries a day, the transportation planner 110 may divide the transportation area 220 in one hundred zones 210. Each of the one hundred zones 210 may represent a sub-area of the transportation area 220 that may experience a daily average of ten deliveries.

In addition, based on transportation constraints and/or other data, the transportation planner 110 may adjust the boundaries of the zones 210 or may split or merge some of the zones 210. Transportation constraints may represent constraints that may influence how efficiently a transportation request may be processed within a zone and, thus, may be used as factors in segmenting the transportation area 220. For example, the transportation constraints may include one or more of a geographic constraint (various landmarks, highways, thoroughfares, rivers, etc.), a user preference (certain delivery drivers preferring certain areas), types of the items to be transported (e.g., bulky versus small items), or transportation location constraints (e.g., access hours to a building, clearances to access an area, etc.). As such, if a certain location (e.g., delivery location) may be more efficiently served by being a part of a particular zone rather than another zone because of one or more transportation constraints, that location may be added to the particular zone.

In an example, the transportation planner 110 may also generate the inter-zone sequence 240 based on historical and other data. For example, the inter-zone sequence may represent a scheme for efficiently progressing across the zones. Thus, the transportation planner 110 may search for a solution that optimizes the scheme. Optimization factors may include travelled distance, travelled time, or used resources. To illustrate, the transportation planner 110 may set two adjoining zones as two consecutive zones in the inter-zone sequence. This set-up may provide a more efficient way to travel across the two zones relative to a scheme where non-adjoining zones are travelled consecutively. Similarly to the above, the transportation planner 110 may also account for transportation constraints to find the most efficient inter-zone sequence 240. For instance, if travelling between two adjoining zones may be more efficient in one direction than the other (e.g., because of traffic flow), the inter-zone sequence 240 may be set according to the more efficient direction. In another example, two zones may be separated by a third zone. An inter-zone sequence may be set such that these two non-adjoining zones are served consecutively (e.g., deliveries are completed in the first zone, then consecutively in the second zone). That may be the case when, for example, a transportation constraint renders this inter-zone sequence more efficient than another inter-zone sequence that includes the adjoining third zone. For instance, direct, high speed routes connecting the two non-adjoining zones may result in the higher efficiency. In another example, local slow speed routes, high traffic, and/or a geographic constraint (e.g., a river) within the third zone may result in the higher efficiency associated with the inter-zone sequence including the two non-adjoining zones.

The above examples of FIG. 2 are provided for illustrative purposes. In particular, geographic zones for a geographic area are described. However, embodiments described herein may not be limited to geographic zones or geographic areas. In particular, a collection of transportation requests may be analyzed. A plurality of zones for that collection may be generated based on the analysis. Transportation requests specific to a zone may be a set of requests that share one or more characteristics. Characteristics may include spatial, time, resource, user, and/or item related attributes. For example, a large number of transportation requests may be divided based on geographical locations associated with the requests as illustrated in FIG. 2 or based on geographical road segments. Additionally or alternatively, these transportation requests may be segmented into zones based on windows of time to process the requests (e.g., ten requests to be delivered within an hour may form a zone), needed resources (e.g., requests necessitating particular transportation vehicles may form particular types of zones), list of clients (e.g., clients subscribed to a loyalty program may form particular types of zones), and a type of items (e.g., residential orders may be treated differently from commercial orders). As such, the zones need not be defined by physical or geographical boundaries.

As described herein above, an area (or more generally a group of transportation requests) may be segmented into a plurality of zones. In an example, multiple types of zones may be generated for the same area (or the group of transportation requests). For example, an area may be divided into zones for commercial orders and zones for residential orders. This may allow the transportation planner 110 to customize a transportation plan per type of items (e.g., commercial versus residential). In turn, subscribers (e.g., transportation stations and end users) may be instructed according to the customized plans. For instance, delivery stations may plan for different types of delivery vehicles to deliver commercial orders and residential orders. Divisions other than commercial and residential may be used. For example multiple types of zones for an area may be generated based on one or more of: an item attribute (e.g., residential versus commercial, weight, handling mechanism, etc.), a user attribute (e.g., loyalty clients versus other clients), transportation methods (e.g., rushed deliveries versus other deliveries), needed resources (e.g., one type of delivery vehicle versus another type of delivery vehicle), and/or request densities (e.g., a large number of deliveries to one building versus individual deliveries to a number of buildings). Generally, one or more of these divisions may further increase the efficiency of processing transportation requests by assuming that not all transportation requests should be treated equally. As such, the transportation planner 110 may discriminate between different types of transportation requests (e.g., commercial versus residential) to generate best fitted or optimal plans according to the respective types.

Furthermore, the different types of zones for an area (or a group of transportation requests) may be overlaid on a same map of the area to generate a layered map. FIG. 3 illustrates an example of this overlay. The layered map may be used by the transportation planner 110 to select the appropriate layer given a type of a transportation request and generate a best fitted plan for that transportation request and related transportation requests accordingly.

As illustrated, two layers 310 and 320 may be overlaid for an area 330. However, a larger number of layers may also be used. Each of these layers 310 and 320 may have been generated using techniques similar to those described in connection with FIG. 2. In the example of FIG. 3, the first layer 310 may include a plurality of zones and associated inter-zone sequence for handling transportation requests associated with residential orders. As illustrated, a large number of such orders may be distributed evenly through the area 330. Thus, the zones within the first layer 310 may be distributed evenly throughout the area 330, where each zone may include a similar number of locations (e.g., residential addresses). In comparison, the second layer 320 may include a plurality of zones and associated inter-zone sequence for handling transportation requests associated with commercial orders. Unlike the residential orders, the commercial orders may be concentrated within relatively smaller number of commercial locations (e.g., commercial buildings). Thus, each of these locations may form a zone within the second layer 320.

Once a plurality of zones (of the same type as illustrated in FIG. 2 or of different types as illustrated in FIG. 3) may have been generated, the transportation planner 110 may also generate an intra-zone sequence per zone as illustrated in FIG. 4. Generally a transportation request may be associated with a location. For example, to process a delivery request, an item may be delivered to a delivery location (e.g., an address). Processing transportation requests within a zone may involve using the corresponding locations. Continuing with the previous example, delivering items to four delivery locations may include travelling to the four delivery locations. Accordingly, an intra-zone sequence may represent an order by which the different locations may be used to process the transportation requests within the zone. Referring again to the previous example, an intra-zone sequence to deliver the items may include a travel path or route within the zone, where each of the four locations may represent a point or a stop on that path or route.

To increase the efficiency of processing transportation requests within a zone, the transportation planner 110 may search for the optimal intra-zone sequence given the locations corresponding to the transportation requests. These locations may be determined from the current transportation requests 144. Finding the sequence may represent an optimization problem, the solution of which may be the optimal intra-zone sequence. Various techniques may be used to find the solution to what may be generally formulated as the travelling salesman problem. Because the number of transportation requests to be processed within each zone may be small enough, brute force techniques to resolve the travelling salesman problem may be efficiently and meaningfully implemented. FIG. 4 illustrates an example of a brute force technique, in which all possible sequences of the locations are computed and analyzed. In addition, to optimize the overall processing of transportation requests across multiple zones, information about transportation requests of one zone may be used to generate the intra-zone sequence of another zone as illustrated in FIG. 5. In cases when the number transportation requests within a zone may be too large such that a brute force analysis may not be completed in a timely manner, the intra-zone sequence may represent an acceptable solution (e.g., a best solution from a number of possible solutions) given certain assumptions and/or relative to thresholds for one or more applicable optimization parameters (e.g., travel distance, travel time, etc.). In this case, a heuristic solution may be implemented for example.

Turning to FIG. 4, the figure illustrates a zone 410 having four locations 420, each of the locations 420 corresponding to a transportation request. The four locations 420 are provided for illustrative purposes. A larger or smaller number may also be used. A path 430 may exist between two locations. Two paths in opposing directions between the same two locations may not necessarily be symmetric for different reasons. For example, the path from location “A” to location “B” may not be the same as the path from location “B” to location “A” because of, for instance, respective traffic flows. A sequence within the zone 410 may be composed of the different paths between the locations 420. In this example, because there are four locations 420 and because the paths are not symmetric, there may be a potential of twenty-four different sequences (e.g., a combination of paths between four locations or 4!). The intra-zone sequence may be selected from the twenty-four candidate sequences as the sequence that may result in an optimum solution. The optimization may consider one or more optimization parameters. An example optimization parameter may include a total travelled distance, in which case the intra-zone sequence may represent the shortest travelled distance. Another example optimization parameter may include a total travelled time, in which case the intra-zone sequence may represent the shortest travelled time. Yet another example optimization parameter may include used resources (e.g., number of delivery vehicles, amount of workload such as work hours or headcount, or maximum capacity of delivery vehicles and personnel), in which case the intra-zone sequence may represent the smallest amount of used resources.

To illustrate, and considering the example of travelled distance, the transportation planner 110 may compute the distance along each path (e.g., between location “A” and location “B,” location “B” and location “C, so on and so forth). For each sequence of paths (e.g., A-B-C-D), the total travelled distance may be determined by adding the respective distances of the paths. The transportation planner 110 may select the sequence with the smallest total travelled distance as the intra-zone sequence. If two or more sequences are associated with the same or approximately the same smallest total travelled distance, the transportation planner 110 may select one of these sequences as the intra-zone sequence using different techniques. In one technique, the transportation planner 110 may assess these candidate sequences against one or more other optimization parameters (e.g., total travel time, total amount of used resources, etc.) and select the candidate sequence that may provide the optimal result. In another technique, the transportation planner 110 may use information about another zone. For example, the transportation planner 110 may consider locations and the intra-zone sequence of a next (or previous) zone from the inter-zone sequence. The transportation planner 110 may then select the candidate sequence of the current zone based on minimizing the travel distance (or another parameter) between the exit location of the current zone and the entry location of the next zone (or the exit location of the previous zone and the entry location of the current zone). The candidate zone that minimizes this distance (e.g., the one ending with the proper exit location or starting with the proper entry location) may be set as the intra-zone sequence of the current zone.

In addition to various optimization parameters, different variables may exist and may impact the responses to the transportation requests. For example, particular traffic, weather, seasonal order peaks and dips, and/or events may occur and, accordingly, delay the responses (e.g., deliveries and returns). Such variables may be modeled using different likelihood models (e.g., distribution functions) based on, for instance, the transportation constraints 146. Various techniques may be implemented to find the optimal solution (e.g., the intra-zone sequence) while accounting for these variables, such as a Monte Carlo method. Generally, different realizations of these variables may be simulated based on respective likelihoods (e.g., the distribution functions), and the optimal solution may be sought given these realizations.

While optimizing an intra-zone sequence locally within a zone may represent an optimal solution to process transportation requests of that zone, an additional overall efficiency may be gained by optimizing intra-zone sequences collectively. One technique to do so may involve considering information about transportation requests of one zone when generating the intra-zone sequence of another zone. Such two zones may be adjoining or non-adjoining zones (e.g., two consecutive zones as indicated by an inter-zone sequence). FIG. 5 illustrates an example of this technique.

In particular, each zone may have an entry location and an exit location as defined by the respective intra-zone sequence. For example and as illustrated in FIG. 4, the intra-zone sequence of the zone 410 may have location “A” as the entry location and location “D” as the exit location (assuming that this intra-zone sequence starts at location “A” and ends at location “D”). When another zone is considered, the different locations of the previous adjoining zone may be considered as potential entry locations of the zone. As such, when searching for the intra-zone sequence of this zone, these previous locations (corresponding to transportation requests of the previous adjoining zone) may be considered as part of the optimization problem along with the current locations of the zone (corresponding to transportation requests of the zone). Doing so may in a way represent stitching or concatenating the two adjoining zones by using, for instance, a state machine where inputs of the state machine (e.g., the current locations) may be set as potential outputs of the state machine of the previous adjoining zone (e.g., the previous locations).

Turning to FIG. 5, the figure illustrates an example of three zones, each having three locations (the first zone having locations “A,” “B,” and “C,” the second zone having locations “D,” “E,” and “F,” and the third zone having locations “G,” “H,” and “I”). A state machine per zone may be used. As shown in FIG. 5, a state machine may be represented by a table and a set of scores for illustrative purposes. Nonetheless, other types and representations may be similarly used. The state machine of the first zone may include a table 510 and a set of scores 512. Similarly, the state machines of the second and third zones may include tables 520 and 530, respectively, and sets of scores 522 and 532, respectively.

A table of a zone may list the locations of the zone as potential entry and exit locations. The cells of the tables may include scores representing a cost (e.g., a traveled distance, a traveled time, time taken to service some or all of the transportation requests, or an amount of used resources) to progress between locations. For example, a cell corresponding to entry location “A” and exit location “B” may have a score of “one” indicating that the distance to travel from location “A” to location “B” may be one mile (or some other measure).

A set of scores may list the different combinations of locations (e.g., the potential sequences within a zone) and the respective scores computed from the cells of the corresponding table. For example, a sequence of “A-B-C” may have a score of “five” corresponding to entry location “A” followed by location “B” (with a score of “one”), and location “B” followed by exit location “C” (with a score of “four”). The intra-zone sequence may be derived from the set of scores by selecting the sequence with, for example, the lowest score. In the example first zone, the respective intra-zone sequence may be sequence “C-A-B” (having the lowest score of “three”) corresponding to entry location “C” followed by location “A” and then an exit location “B.”

When generating the intra-zone sequence of the next adjoining zone (e.g., the second zone adjoining the first zone, or the third zone adjoining the second zone), the locations of the previous adjoining zone may be used as potential entry locations. As illustrated, locations “A,” “B,” and “C” of the first zone may be set as potential entry locations of the next adjoining zone (e.g., the second zone). Similarly, the locations “D,” “E,” and “F” of the second zone may be set as potential entry locations of the next adjoining zone (e.g., the third zone).

To do so, the table 520 of the second zone may be expanded to include the previous locations (e.g., locations “A,” “B,” and “C”). The set of scores 522 of the second zone may be derived from the table 520. The sequence with the lowest score may be selected as the intra-zone sequence of the second zone. To illustrate, if the sequence “A-D-F-E” with a score of “six” is the lowest scoring sequence, the intra-zone sequence of the second zone may be “D-F-E” indicating that “D” may be the actual entry location of the second zone, followed by location “F” and exit location “E.” Similar processing may be implemented for the third zone by expanding the table 530 to use “D,” “E,” and “F” as potential entry locations.

In this way, transportation requests (e.g., as associated with locations) of a first zone may be considered and may contribute to generating an intra-zone sequence of a second zone. In other words, the intra-zone sequence may represent an optimal solution for the second zone based not only on the transportation requests of that zone, but also on those of the first zone.

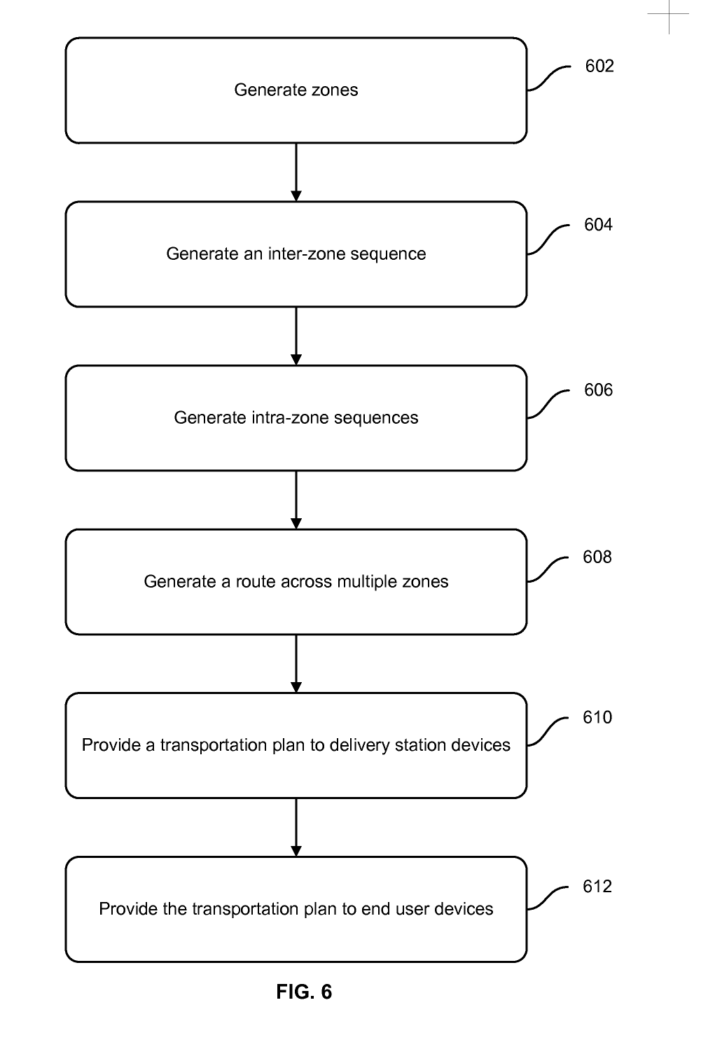

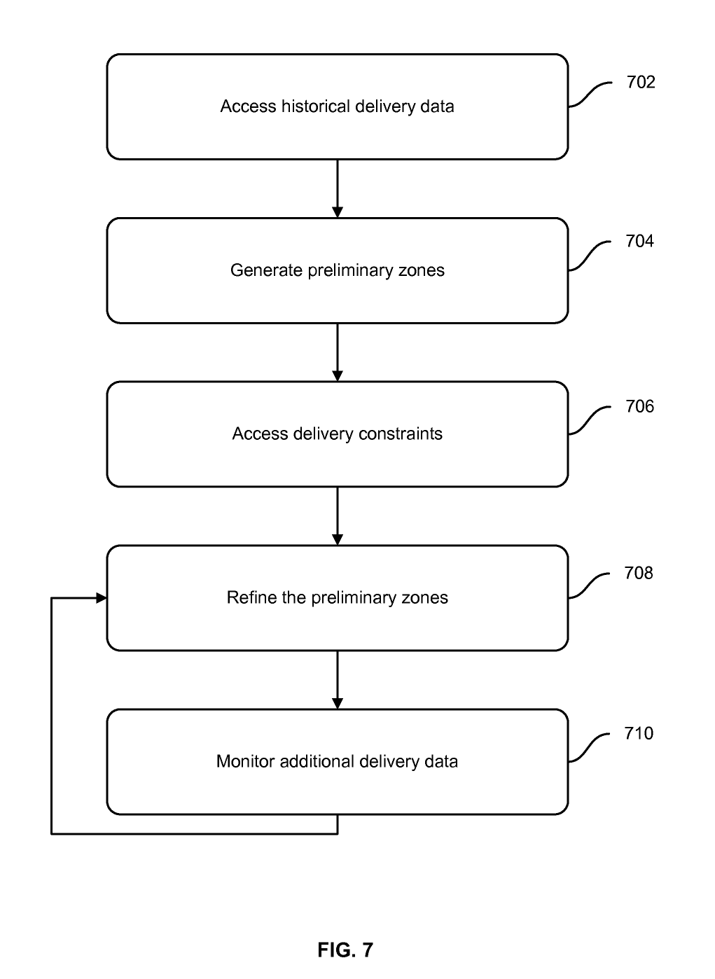

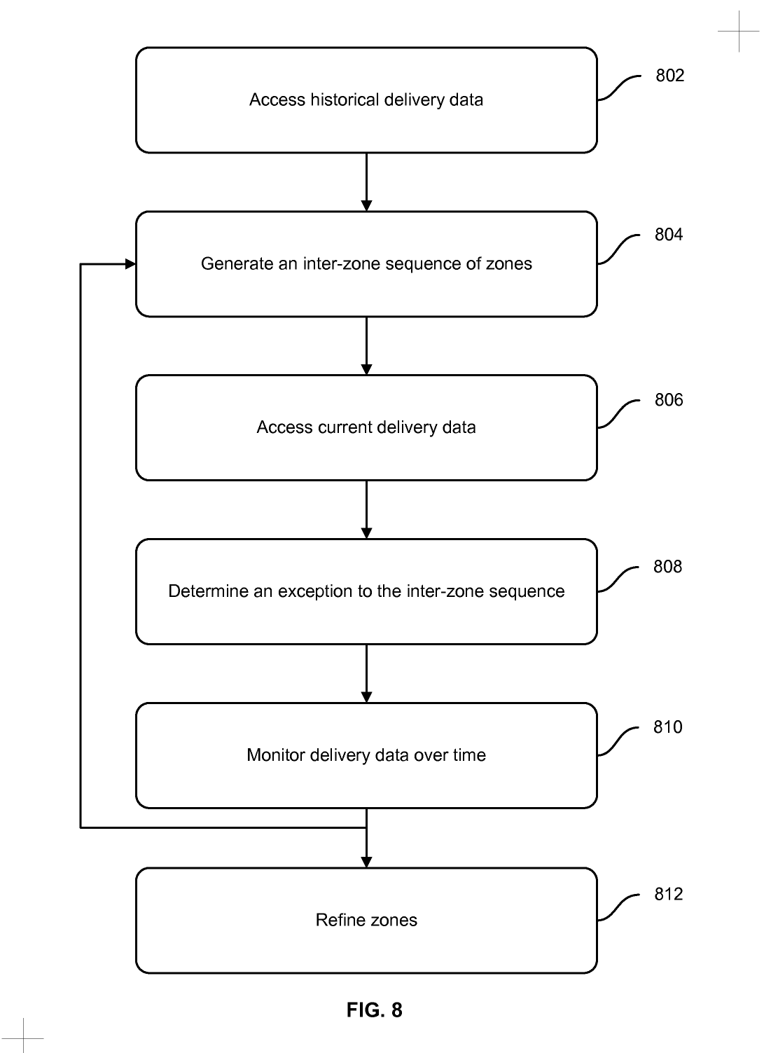

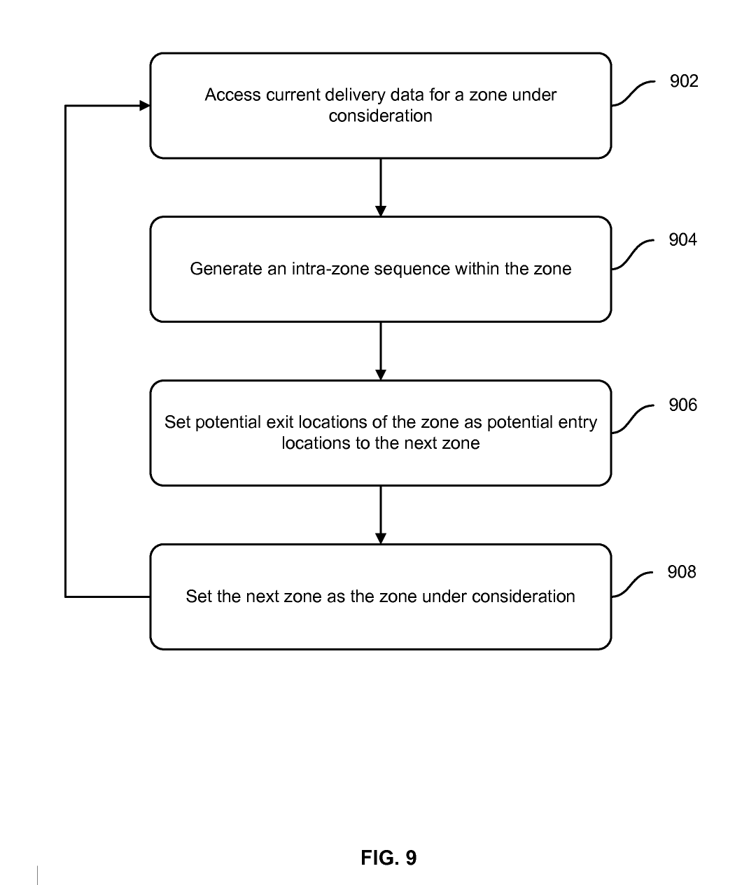

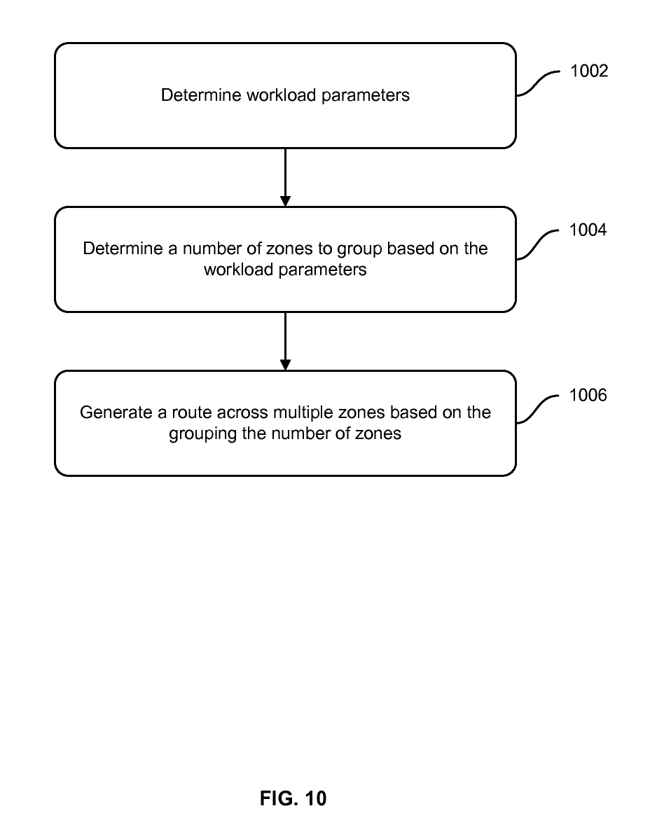

Turning to FIGS. 6-10, the figures illustrate example flows for generating a transportation plan. In particular, FIG. 6 illustrates an example end-to-end flow for generating and providing a transportation plan to subscribers. FIG. 7 illustrates an example flow for generating zones. FIG. 8 illustrates an example flow for generating an inter-zone sequence. FIG. 9 illustrates an example flow for generating an intra-zone sequence. FIG. 10 illustrates an example flow for generating routes. Some operations across the example flows may be similar. Such similarities are not repeated herein in the interest of clarity of explanation.

In the illustrative operations, some of the operations or functions may be embodied in, and fully or partially automated by, components executed by one or more processors. For example, a transportation planner, such as the transportation planner 110, hosted on a computing system of a service provider may be configured to perform some or all of the operations. Nevertheless, other, or a combination of other, computing systems and components may be additionally or alternatively used. Also, while the operations are illustrated in a particular order, it should be understood that no particular order is necessary and that one or more operations may be omitted, skipped, and/or reordered.

In the interest of clarity of explanation, the example flows of FIGS. 6-10 illustrate planning of deliveries. Nevertheless, the embodiments described herein are not limited as such. Instead, the embodiments may similarly apply to other types of transportation requests.

The example flow of FIG. 6 may start at operation 602, where zones may be generated. The zones may correspond to an area and may represent a layer particular to a type of delivery requests (e.g., residential deliveries). In an example, the transportation planner may access historical data and transportation constraints relevant to the delivery requests of that type and specific to that area. Based on this data and based on a desired capacity of deliveries to be managed per zone, the transportation planner may generate the zones.

At operation 604, an inter-zone sequence may be generated. For example, based on the historical data and/or the transportation constraints, the transportation planner may determine the most efficient scheme to progress across the zones. This scheme may form the inter-zone sequence. In an example, the inter-zone sequence may be generated at a static frequency relative to the generation of intra-zone sequences (further described under operation 606). In other words, the frequency of generating the inter-zone sequence may be smaller than the frequency of generating the intra-zone sequences. For instance, the inter-zone sequence may be generated on a weekly, monthly, or seasonal basis whereas the intra-zone sequence may be generated daily. This relatively static frequency may reduce usage of computation resources associated with generating transportation plans.

At operation 606, intra-zone sequences may be generated. In an example, the transportation planner may access current delivery requests for the area. Applicable delivery requests (e.g., ones associated with residential deliveries) may be further analyzed using the generated zones. For each zone, the transportation planner may find an optimal solution according to one or more optimization parameters as illustrated in FIGS. 4 and 5. An optimal solution of a zone may be set as the intra-zone sequence. Remaining or other delivery requests (e.g., ones associated with commercial deliveries) may be similarly analyzed using other applicable layers of zones. In an example, intra-zone sequences may be generated at a dynamic frequency relative to the generation of the inter-zone sequence. In other words, the frequency of generating the intra-zone sequences may be larger than the frequency of generating the inter-zone sequence. For instance, the intra-zone sequence may be generated on a daily basis. This relatively dynamic frequency may facilitate planning for current and most up-to-date transportation requests.

At operation 608, routes across the zones may be generated. A route across multiple zones may include the intra-zone sequences of these zones. Transportation requests associated with the route may be served by a single transportation vehicle. In an example, the transportation planner may estimate the workload of deliveries per zone (e.g., the number of deliveries, the amount of used time to complete the deliveries, the used resources, the travelled distance, etc.). The transportation planner may accordingly group multiple zones based on a total desired workload. For instance, if delivery of items is estimated to need forty-five minutes per zone, the transportation planner may group eight zones together as representing a day's worth of workload. The intra-zone and inter-zone sequences of the grouped zones may represent a route across such zones.

At operation 610, a transportation plan may be provided to delivery station devices. The transportation plan may include information about the zones, the inter-zone sequence, the intra-zone sequences, and routes. In an example, the transportation planner may transmit the transportation plan or the information to the delivery station devices over a network as illustrated in FIG. 1. In turn, the delivery stations may use the received data to facilitate various delivery-related operations and functionalities. For example, the delivery station devices may display the zones, the inter-zone sequence, the intra-zone sequences, and/or the routes on user interfaces. In another example, the delivery station devices may generate instructions related to deliveries of items based on the transportation plan. For instance, the delivery station devices may indicate how the items should be sorted, packaged, labeled, and added to delivery containers.

To illustrate, a delivery station device may receive the transportation plan. Based on information about the inter-zone sequence, the delivery station device may generate instructions (or control other devices and systems such as automated sorting systems) to sort, package, and add items to containers corresponding to the zones. For instance, an item to be delivered to one zone would be added to the container of that zone. The containers would also be sequenced according to the inter-zone sequence. For instance, in an inter-zone sequence of ten zones, a container corresponding to zone ten would be placed for pick up prior to the container of zone nine, and so on and so forth, such that when loaded on a delivery truck, the ten containers may be more easily loaded in a descending order. Furthermore, the delivery station device may generate instructions (or control other devices and systems such label printers) to label packages based on the intra-zone sequences. For instance, packages of one zone may be added to the container of that zone. Because there may a relatively small or manageable number of the packages (e.g., ten packages), labeling the packages may be simplified to improve the efficiency of preparing for and delivering the packages. In an example, non-sequential, human-readable identifiers may be used for the labels, such as short texts, symbols, images, or other forms of identifiers. In this way, the sequence of these packages within the container may no longer be important. Thus, adding more packages to the container may be achieved without being constrained to any previously determined sequence for the packages. Additionally, the intra-zone sequence may be dynamically determined or updated at any point up to delivery in the zone because, in part, the labels may help identify the right package at the right location, even if the intra-zone sequence may have been changed after the packages were added to the container.

At operation 612, the transportation plan may also be provided to end user devices. For example, the transportation planner may transmit the transportation plan or information about various portions of the plan to the end user devices over a network as illustrated in FIG. 1. In turn, the end user devices may use the received data to facilitate various delivery-related operations and functionalities. For example, the end user devices may display the zones, the inter-zone sequence, the intra-zone sequences, and/or the routes on user interfaces. In another example, the end user devices may generate instructions related to deliveries of items based on the transportation plan. For instance, the end user devices may indicate how the delivery containers map to the zones and how items within a delivery container map to delivery locations within the respective zone. This may include, for example, displaying on an end user device the delivery locations and the corresponding package labels (e.g., the unique identifiers or images attached to the packages) on a map. In yet another example, the end user devices may allow contractors and/or third parties to bid on routes. In addition, if an end user accepts a route and a change to an intra-zone sequence changes during a delivery along the route, the end user device may provide an indication of the change to the transportation planner. The indication may be provided based on an action of the end user (e.g., a click on a user interface) or automatically based on a detection of the change (e.g., based on inconsistencies between GPS data of the delivery vehicle and the intra-zone sequence). The transportation planner may collect such indications over time and use them as a parameter for refining future intra-zone sequences.

Turning to FIG. 7, the figure illustrates an example flow for generating zones. This example flow may be implemented under operation 602 of FIG. 6. In particular, the example flow may start at operation 702, where historical delivery data may be accessed. For example, the transportation planner may access and/or receive such data from a data store as illustrated in FIG. 1.

At operation 704, preliminary zones may be generated. In an example, the transportation planner may determine a desired delivery capacity per zone based on, for example, service provider input or some other source of data. The transportation planner may generate the preliminary zones given the historical delivery data and the desired delivery capacity. For instance, if one thousand deliveries are expected on a daily basis and each zone is expected to handle ten deliveries, the transportation planner may generate one hundred preliminary zones.

At operation 706, one or more transportation or delivery constraints may be accessed. A transportation or delivery constraint may influence how efficiently a delivery may be performed within a zone and, thus, may be used as a factor in refining the boundaries between the preliminary zones. For example, the transportation or delivery constraint may include a geographic constraint (various landmarks, highways, rivers, etc.), a user preference (certain delivery drivers preferring certain areas), types of the items to be delivered (e.g., bulky versus small items), and/or delivery location constraints (e.g., access hours to a building, clearances to access an area, etc.). In an example, the transportation planner may access the transportation or delivery constraint(s) from a data store, such as one storing the transportation constraints 146 as illustrated in FIG. 1.

At operation 708, the preliminary zones may be refined. In an example, the transportation planner may refine such zones based on the transportation or delivery constraint(s). For example, the transportation planner may adjust the boundaries between zones or even split or merge multiple zones when such a change may increase the efficiency of delivering items. For instance, if a delivery location found in one preliminary zone would be more efficiently served when added to another preliminary zone, the transportation planner may refine both of these zones such that the delivery location may be re-allocated from the first zone to the other zone.

At operation 710, delivery data may be monitored over time. As deliveries are performed, the resulting data may become part of the historical data. Updates to the historical data may trigger (e.g., at time intervals or based on the amount of updates) the transportation planner to further refine the zones. In a way, the monitoring of the delivery data over time may facilitate a feedback loop such that the overall efficiency of responding to delivery requests may be improved continuously.

Turning to FIG. 8, the figure illustrates an example flow for generating an inter-zone sequence. This example flow may be implemented under operation 604 of FIG. 6. In particular, the example flow may start at operation 802, where historical delivery data may be accessed. At operation 804, an inter-zone sequence may be generated based on the historical delivery data. In an example, the transportation planner may sequence the zones such that travelling between the zones may represent the most efficient travelling scheme. For instance, two adjoining or non-adjoining zones may be set as two consecutive zones in the scheme.

At operation 806, current delivery data or current transportation requests may be accessed. In an example, the transportation planner may access such data from a data store as illustrated in FIG. 1. At operation 808, an exception to the inter-zone sequence may be determined. An exception may represent an acceptable deviation from the sequence. In an example, the transportation planner may determine the exception based on the current delivery data. In particular, if changing a sequence for an item delivery increases efficiency given the current delivery data, that change may be set as the exception. For instance, a street may be divided between two zones. Deliveries to one side of the street may be part of the first zone and deliveries to the other side may be part of the second zone. If the current delivery data indicates a heavy density of deliveries to the first side and a light density of deliveries to the second side, delivering items to both sides of that street as part of the first zone may be more efficient than dividing the deliveries between the two zones. As such, the transportation planner may generate an exception by which the deliveries to the second side may become part of the first zone.

At operation 810, delivery data may be monitored over time. As such, current delivery data may become part of the historical delivery data once deliveries are completed. By monitoring such data over time, the transportation planner may refine the zones, as illustrated at operation 812, and the inter-zone sequence, as illustrated at operation 804. For example, the transportation planner may determine the frequency by which an exception may be occurring over time. If the frequency exceeds a threshold (e.g., occurs frequently enough), the transportation planner may change the boundaries between the zones or may change the inter-zone sequence based on the type of the exception such that the exception becomes the norm.

Turning to FIG. 9, the figure illustrates an example flow for generating an intra-zone sequence for a zone. This example flow may be implemented under operation 606 of FIG. 6. In particular, the example flow may start at operation 902, where current delivery data or current transportation requests for a zone under consideration may be accessed.

At operation 904, an intra-zone sequence within the zone may be generated. In an example, the transportation planner may implement techniques similar to those described in connection with FIGS. 4 and 5 to find a solution to an optimization problem and set the solution as the intra-zone sequence. For instance, delivery requests of the zone may correspond to delivery locations. The delivery locations may be determined from the current delivery data. Combinations of delivery locations may be generated. Each combination may represent a sequence of locations. Scores of the combinations may be determined. The combination with a score satisfying one or more optimized parameters (e.g., the smallest travelled distance, the shortest travel time, etc.) may be selected as the intra-zone sequence.

At operation 906, exit locations of the zone may be set as potential entry locations to the next zone. This operation may represent stitching of zones such that data about the deliveries from the current zone under consideration may be used to influence the selection of the intra-zone sequence of the next zone.

At operation 908, the next zone may be set as the zone under consideration. This operation may be iteratively followed by operations 902-906 such that intra-zone sequences may be generated for different zones. By considering data across multiple zones, additional efficiencies resulting from usage of the intra-zone sequences may be gained.

Turning to FIG. 10, the figure illustrates an example flow for generating a route. This example flow may be implemented under operation 608 of FIG. 6. In particular, the example flow may start at operation 1002, where one or more workload parameters may be determined. Such parameters may include, for example, a total number of deliveries to complete, a total travelled distance to deliver the items, a total amount of work hours to complete the deliveries, amount and/or type of resources used, total necessitated headcount, etc.

At operation 1004, a number of zones to be grouped may be determined based on the workload parameter(s). For example, the transportation planner may estimate the workload to complete deliveries within a zone given the respective intra-zone sequence. The transportation planner may use the estimated workload per zone to determine the number of zones to group such that the grouped zones may result in a total workload that may meet the workload parameter(s). For instance, if forty five minutes of workload are estimated per zone and a total workload of eight hours a day is desired (including breaks, refueling, and extraneous support activities), the transportation planner may determine that eight zones may be grouped into each route that is assigned to delivery personnel. In another illustrative example, the transportation planner may balance the workload (e.g., distance, hours, used resources, etc.) across the zones by generating the routes such that the resulting workloads may be approximately the same. For instance, a first route may correspond to a group of six zones and a total workload of eight hours. A second route may correspond to a different number of zones (e.g., twelve zones) but to a similar total workload (e.g., approximately eight hours). In this way, usage of resources (e.g., delivery vehicles and personnel) may be balanced across the zones.

At operation 1006, a route across multiple zones may be generated. In an example, the transportation planner may group the determined number of zones and set the respective intra-zone sequences as the route to be assigned to delivery personnel.

Turning to FIG. 11, that figure illustrates an example end-to-end computing environment for generating transportation plans for items offered from an electronic marketplace. In this example, a service provider may implement a transportation planner to generate the transportation plan based on historical and current transportation requests. The items may be listed for offering by one or more sellers and/or the service provider at the electronic marketplace and may be available for ordering by one or more customers.

In a basic configuration, a user 1110 (e.g., a seller or a buyer) may utilize a user device 1112 to access local applications, a web service application 1120, a user account accessible through the web service application 1120, a web site or any other network-based resources via one or more networks 1180. In some aspects, the web service application 1120, the web site, and/or the user account may be hosted, managed, and/or otherwise provided by one or more computing resources of the service provider, such as by utilizing one or more service provider devices 1130. The user 1110 may use the local applications and/or the web service application 1120 to interact with network-based resources (e.g., servers hosting web pages of the electronic marketplace) of the service provider and perform user-related transactions. These transactions may include, for example, offering items for sale at the electronic marketplace, purchasing items, requesting deliveries of items, requesting returns of items, etc. Other types of users may also exist and, accordingly, other types of transactions may be performed. For example, the user 1110 may represent a subscriber as described in FIG. 1. The web service application 1120 and/or the user account may facilitate accessing information about transportation plans and providing transportation-related services based on such plans.

In some examples, the user device 1112 may be any type of computing devices such as, but not limited to, a mobile phone, a smart phone, a personal digital assistant (PDA), a laptop computer, a thin-client device, a tablet PC, etc. In one illustrative configuration, the user device 1112 may contain communications connection(s) that allow the user device 1112 to communicate with a stored database, another computing device or server, user terminals, and/or other devices on the networks 1180. The user device 1112 may also include input/output (I/O) device(s) and/or ports, such as for enabling connection with a keyboard, a mouse, a pen, a voice input device, a touch input device, a display, speakers, a printer, etc.

The user device 1112 may also include at least one or more processing units (or processor device(s)) 1114 and at least one memory 1116. The processor device(s) 1114 may be implemented as appropriate in hardware, computer-executable instructions, firmware, or combinations thereof. Computer-executable instructions or firmware implementations of the processor device(s) 1114 may include computer-executable or machine-executable instructions written in any suitable programming language to perform the various functions described.

The memory 1116 may store program instructions that are loadable and executable on the processor device(s) 1114, as well as data generated during the execution of these programs. Depending on the configuration and type of user device 1112, the memory 1116 may be volatile (such as random access memory (RAM)) and/or non-volatile (such as read-only memory (ROM), flash memory, etc.). The user device 1112 may also include additional storage, which may include removable storage and/or non-removable storage. The additional storage may include, but is not limited to, magnetic storage, optical disks, and/or tape storage. The disk drives and their associated computer-readable media may provide non-volatile storage of computer-readable instructions, data structures, program modules, and other data for the computing devices. In some implementations, the memory 1116 may include multiple different types of memory, such as static random access memory (SRAM), dynamic random access memory (DRAM), or ROM.

Turning to the contents of the memory 1116 in more detail, the memory may include an operating system (O/S) 1118 and the one or more application programs or services for implementing the features disclosed herein including the web service application 1120. In some examples, the user device 1112 may be in communication with the service provider devices 1130 via the networks 1180, or via other network connections. The networks 1180 may include any one or a combination of many different types of networks, such as cable networks, the Internet, wireless networks, cellular networks, and other private and/or public networks. While the illustrated example represents the user 1110 accessing the web service application 1120 over the networks 1180, the described techniques may equally apply in instances where the user 1110 interacts with the service provider devices 1130 via the user device 1112 over a landline phone, via a kiosk, or in any other manner. It is also noted that the described techniques may apply in other client/server arrangements (e.g., set-top boxes, etc.), as well as in non-client/server arrangements (e.g., locally stored applications, peer-to-peer systems, etc.).

As described briefly above, the web service application 1120 may allow the user 1110 to interact with the service provider devices 1130 to conduct transactions involving items, transportation requests, and/or transportation plans. The service provider devices 1130, perhaps arranged in a cluster of servers or as a server farm, may host the web service application 1120. These servers may be configured to host a web site (or combination of web sites) viewable via the user device 1112. Other server architectures may also be used to host the web service application 1120. The web service application 1120 may be capable of handling requests from many users and serving, in response, various interfaces that may be rendered at the user devices such as, but not limited to, a web site. The web service application 1120 may interact with any type of web site that supports interaction, including social networking sites, electronic retailers, informational sites, blog sites, search engine sites, news and entertainment sites, and so forth. As discussed above, the described techniques may similarly be implemented outside of the web service application 1120, such as with other applications running on the user device 1112.

The service provider devices 1130 may, in some examples, provide network-based resources such as, but not limited to, applications for purchase and/or download, web sites, web hosting, client entities, data storage, data access, management, virtualization, etc. The service provider devices 1130 may also be operable to provide web hosting, computer application development, and/or implementation platforms, or combinations of the foregoing to the user 1110.

The service provider devices 1130 may be any type of computing device such as, but not limited to, a mobile phone, a smart phone, a personal digital assistant (PDA), a laptop computer, a desktop computer, a server computer, a thin-client device, a tablet PC, etc. The service provider devices 1130 may also contain communications connection(s) that allow service provider devices 1130 to communicate with a stored database, other computing devices or servers, user terminals, and/or other devices on the network 1180. The service provider devices 1130 may also include input/output (I/O) device(s) and/or ports, such as for enabling connection with a keyboard, a mouse, a pen, a voice input device, a touch input device, a display, speakers, a printer, etc.

Additionally, in some embodiments, the service provider devices 1130 may be executed by one or more virtual machines implemented in a hosted computing environment. The hosted computing environment may include one or more rapidly provisioned and released network-based resources. Such network-based resources may include computing, networking, and/or storage devices. A hosted computing environment may also be referred to as a cloud computing environment. In some examples, the service provider devices 1130 may be in communication with the user devices 1112 via the networks 1180, or via other network connections. The service provider devices 1130 may include one or more servers, perhaps arranged in a cluster, or as individual servers not associated with one another.

In one illustrative configuration, the service provider devices 1130 may include at least one or more processing units (or processor devices(s)) 1132 and at least one memory 1134. The processor device(s) 1132 may be implemented as appropriate in hardware, computer-executable instructions, firmware, or combinations thereof. Computer-executable instruction or firmware implementations of the processor device(s) 1132 may include computer-executable or machine-executable instructions written in any suitable programming language to perform the various functions described.

The memory 1134 may store program instructions that are loadable and executable on the processor device(s) 1132, as well as data generated during the execution of these programs. Depending on the configuration and type of the service provider devices 1130, the memory 1134 may be volatile (such as random access memory (RAM)) and/or non-volatile (such as read-only memory (ROM), flash memory, etc.). The service provider devices 1130 may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 1134 may include multiple different types of memory, such as static random access memory (SRAM), dynamic random access memory (DRAM), or ROM.

Additionally, the computer storage media described herein may include computer-readable communication media such as computer-readable instructions, program modules, or other data transmitted within a data signal, such as a carrier wave, or other transmission. Such a transmitted signal may take any of a variety of forms including, but not limited to, electromagnetic, optical, or any combination thereof. However, as used herein, computer-readable media does not include computer-readable communication media.

Turning to the contents of the memory 1134 in more detail, the memory may include an operating system (O/S) 1136, code for an electronic marketplace 1138 (e.g., code for a front end system that may include web pages and code for a back end system that may facilitate processing items), historical transportation data 1140, current transportation requests 1142, transportation constraints 1144, and code for a transportation planner 1146. Although FIG. 11 illustrates the various data as stored in the memory 1134, the data or portions of the data may be additionally or alternatively stored at a storage device remotely accessible to the service provider devices 1130.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as that included in the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z each to be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
generating, by a computer system associated with an electronic marketplace, a set of zones for a delivery area associated with deliveries of items available from the electronic marketplace, the set of zones generated based at least in part on historical information associated with the deliveries and based at least in part on a predefined volume of the deliveries per zone;
generating, by the computer system, an inter-zone sequence to follow between the set of zones in association with the deliveries, the inter-zone sequence generated based at least in part on the historical information;
receiving, by the computer system, information about delivery locations within a zone and an adjoining zone of the set of zones, the delivery locations associated with ordered items from the electronic marketplace, the adjoining zone identified based at least in part on the inter-zone sequence; and
generating, by the computer system, an intra-zone sequence to follow within the zone in association with delivering a portion of the ordered items corresponding to the zone, the intra-zone sequence generated based at least in part on the information about the delivery locations within the zone and the adjoining zone.

2. The computer-implemented method of claim 1, wherein the intra-zone sequence is generated at a first frequency, wherein the inter-zone sequence is generated at a second frequency, and wherein the first frequency is higher than the second frequency.

3. The computer-implemented method of claim 1, wherein the set of zones are generated based at least in part on one or more of: a geographic constraint, a user preference, types of the ordered items, or delivery location constraints.

4. The computer-implemented method of claim 1, further comprising:
providing information about the intra-zone sequence to a computer device of a delivery station, the information about intra-zone sequence causing the computer device to generate instructions for organizing the portion of the ordered items in a delivery container corresponding to the zone; and
providing the information about the intra-zone sequence to an end user device, the information about the intra-zone sequence causing the end user device to generate instructions for delivering the portion of the ordered items from the delivery container to corresponding delivery locations within the zone.

5. A computer-implemented method, comprising:
generating, by a computer system, a set of zones each associated with transportation requests, the set of zones generated based at least in part on historical information associated with the transportation requests and based at least in part on a capacity per zone;
generating, by the computer system, an inter-zone sequence for the set of zones indicating a sequence to process the transportation requests across the set of zones;
accessing, by the computer system, information associated with a set of the transportation requests corresponding to a zone of the set of zones and with another set of the transportation requests corresponding to another zone of the set of zones, the other zone identified based at least in part on the inter-zone sequence; and
generating, by the computer system, an intra-zone sequence for the zone based at least in part on the information associated with the set and the other set of transportation requests, the intra-zone sequence indicating a sequence to process the set of the transportation requests within the zone.

6. The computer-implemented method of claim 5, wherein the transportation requests comprise deliveries of items available from an electronic marketplace and are processed on a daily basis to generate intra-zone sequences, wherein the set of zones represent a delivery area and are generated at time intervals greater than the daily basis.

7. The computer-implemented method of claim 5, wherein the capacity comprises at least one of: a quantity of transportation requests to process, available resources to process transportation requests, or an amount of workload allocated to process transportation requests.

8. The computer-implemented method of claim 5, wherein the zone comprises at least one of a geographical boundary, a group of geographical locations, a group of geographical road segments, a group of requesters associated with the transportation requests, or a window of time.

9. The computer-implemented method of claim 5, wherein the set of zones are generated based at least in part on a characteristic common to the transportation requests, wherein the characteristic comprises at least one of: geographical locations associated with the transportation requests, times to process the transportation requests, resources to process the transportation requests, clients associated with the transportation requests, or types of items associated with the transportation requests.

10. The computer-implemented method of claim 5, wherein processing the set of transportation requests within the zone comprises providing a transportation service at locations associated with the transportation requests within the zone, wherein generating the intra-zone sequence comprises:
identifying the locations within the zone;
generating potential sequences of the locations, the potential sequences representing potential intra-zone sequences;
computing scores corresponding to the potential sequences and associated with processing the set of transportation requests according to the corresponding potential sequences; and
selecting a sequence of the potential sequences based at least in part on the scores, the sequence representing the intra-zone sequence for the zone.

11. The computer-implemented method of claim 10, wherein the scores comprise at least one of: a traveled distance, a traveled time, time taken to service a transportation request, or an amount of used resources, and wherein the sequence is selected based at least in part on having a minimum score.

12. The computer-implemented method of claim 10, wherein the intra-zone sequence comprises an entry location and an exit location within the zone, and wherein generating the intra-zone sequence further comprises at least one of:
utilizing locations within an adjoining zone as potential entry locations to the zone, the potential entry locations utilized to generate the potential sequences, or
utilizing the locations within the zone as potential entry locations to the adjoining zone, the potential entry locations generated as part of the potential sequences.

13. A system comprising:
one or more processors; and
one or more computer-readable storage media comprising instructions that, when executed with the one or more processors, cause the system to at least:
generate a set of zones based at least in part on historical information associated with transportation requests and based at least in part on a capacity per zone;
generate an inter-zone sequence based at least in part on the historical information;
access information about a zone and another zone of the set of zones based at least in part on the inter-zone sequence, the information associated with a set of the transportation requests corresponding to the zone and to the other zone; and
plan a route comprising the zone by at least:
generating an intra-zone sequence for the zone based at least in part on the information associated with the zone and the other zone, the intra-zone sequence indicating a sequence to process the transportation requests specific to the zone; and
connecting the intra-zone sequence of the zone with another intra-zone sequence of the other zone in accordance with the inter-zone sequence.

14. The system of claim 13, wherein accessing the information comprises:
determining a characteristic of an item associated with a transportation request; and
selecting the set of zones from available zones based at least in part on the characteristic.

15. The system of claim 13, wherein the inter-zone sequence is generated per season, month, or week, and wherein the intra-zone sequence is generated per day or shift.

16. The system of claim 13, wherein the instructions when executed with the one or more processors further cause the system to at least:
estimate a workload associated with processing the transportation requests specific to the zone based at least in part on the intra-zone sequence; and
add the other intra-zone sequence of the other zone to the route based at least in part on the workload of the zone.

17. The system of claim 16, wherein the transportation requests are associated with one or more of: delivering items or returning items, and wherein the instructions when executed with the one or more processors further cause the system to at least:
provide information about the route to subscriber devices; and
receive an indication from a subscriber device of an acceptance of the route or of a change to the intra-zone sequence.

18. The system of claim 13, wherein the transportation requests are associated with delivering items, wherein the instructions when executed with the one or more processors further cause the system to at least provide information about the intra-zone sequence to a computing system of a delivery station configured to generate a plan to prepare the items for delivery based at least in part on the information about the intra-zone sequence.

19. The system of claim 18, wherein the plan comprises associating a subset of the items with a container specific to the zone and generating labels for the subset of the items independently of the intra-zone sequence.

20. The system of claim 19, wherein the instructions when executed with the one or more processors further cause the system to provide information about the intra-zone sequence, the container, and the labels to an end user device.
